(19) United States
(12) Patent Application Publication
(10) Pub. No.: US 2011/0013917 A1
(43) Pub. Date: Jan. 20, 2011

(54) DEVELOPING DEVICE AND METHOD FOR DETECTING DETERIORATION OF DEVELOPER

(75) Inventors: Takashi Hatakeyama, Kanagawa-ken (JP); Takao Izumi, Kanagawa-ken (JP); Hiroshi Murata, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/824,575

(22) Filed: Jun. 28, 2010

(30) Foreign Application Priority Data
Jul. 15, 2009 (JP) 2009-166315

(51) Int. Cl. G03G 15/08

(52) U.S. Cl. 399/27

(57) ABSTRACT

According to one embodiment, a developing device includes a developer container to contain developer having toner and carrier, a toner replenishing unit to replenish the toner to the developer container, a carrier replenishing unit to replenish the carrier to the developer container, a discharge portion to discharge the developer from the developer container, a developer feeder to support magnetically the developer in the developer container and to feed the toner in the developer to a photoconductor on which an electrostatic latent image is formed, an electric conductor, provided separately from the photoconductor, to which the toner out of the developer supported by the developer feeder adheres, a detecting unit to detect a density of the toner adhered to on the electric conductor, and a controller to judge a deterioration status of the developer based on a detection result of the detecting unit and to replenish the toner and the carrier from the toner replenishing unit and the carrier replenishing unit to the developer container.

### CROSS-REFERENCE TO RELATED APPLICATIONS

This application is based upon and claims the benefit of priority from Japanese Patent Application No. 2009-166315, filed on Jul. 15, 2009; the entire contents of which are incorporated herein by reference.

### FIELD

Embodiments described herein relate generally to a developing device to develop an electrostatic latent image formed on a photoconductor with developer, and a method for detecting deterioration of developer.

### BACKGROUND

In image forming, firstly an electrostatic latent image formed on a photoconductor is developed with developer. A toner image obtaining by developing is transferred on a sheet. The toner image is fixed on the sheet. The developer includes toner and carrier.

Two-component developer is having toner and carrier to carry the toner. The toner is charged by the frictional charging caused when the toner and the carrier are agitation mixed. The charged toner adheres electrostatically to the electrostatic latent image on the photoconductor.

When frictions and collisions are repeated by agitation mixing the toner and the carrier, a part of the toner adheres to the carrier, so that the carrier is contaminated. Or, deterioration of the developer (carrier, particularly) takes place, such as a coating layer at the surface of the carrier is peeled off and so on. When the deterioration of the developer progresses, the charging ability of the carrier to the toner degrades gradually. Charging fault of the toner takes place by the degradation of the charging ability. A problem took place that toner adheres to an area corresponding to a non-image area (white area) on the photoconductor by the charging fault of the toner and the cleanness of the image degrades.

To prevent the degradation of the image property, a part of the developer is overflowed forcibly from the developing device so that the developer with degraded charging ability is discharged from the developer case. Along with the discharge, the developer is changed by newly replenishing the carrier and the toner. To maintain the charging ability of the developer and to suppress the degradation of the image property were intended by changing the developer.

But, in the above-described construction, the carrier is always replenished in the same proportion to the toner replenished amount. The deterioration of the carrier depends also on the status of using the image forming apparatus. For the reason, if the carrier is always replenished in the same proportion to the toner replenished amount, the toner density in the developer will change. By the change of the toner density, the image to be developed may be different. As the carrier is discharged in proportion to the toner consumption amount in a condition that the carrier does not almost deteriorate, the wasteful consumption of the carrier may be caused.

For the reason, to perform precisely the replenishment and discharge control of the developer based on the actual deterioration of the developer ties up with the stabilization of the charging ability of the developer and is necessary for suppressing the degradation of the image property. In addition, the wasteful consumption of the carrier can be reduced.

There is a case provided with an image density sensor which detects deterioration state of developer by detecting scumming due to a toner density at an area (non-image area) except an area in which an image is formed on a photoconductor (JP-A 2006-208564 (Kokai)). A replenishing amount of the developer is controlled depending on the deterioration state. The level of the deterioration of the developer is discriminated by detecting an amount of the toner of charging fault which adheres to the non-image area of the photoconductor. But in case of this method, a processing to discriminate the non-image area on the photoconductor is required in case of performing the deterioration detection.

### BRIEF DESCRIPTION OF THE DRAWINGS

FIG. 1 is a sectional view showing an internal construction of an image forming apparatus;

FIG. 2 is a schematic diagram of an image forming unit in a first embodiment seen from a direction perpendicular to a sheet conveying direction;

FIG. 3 is a schematic diagram of a circumference portion of a photoconductor in the first embodiment seen from the sheet conveying direction;

FIG. 4 is a plan view of a developing device seen from the above;

FIG. 5 is a graph showing a relation between a charging amount of the toner and a toner adhesion density adhered to a surface of a ring;

FIG. 6 is a block diagram to perform replenishment and discharge control of the developer;

FIG. 7 is a schematic diagram of a circumference portion of a photoconductor in a second embodiment seen from the sheet conveying direction;

FIG. 8 is a sectional view of a ring in the second embodiment;

FIG. 9A and FIG. 9B are perspective views of the circumference portion of the photoconductor in the second embodiment;

FIG. 10A and FIG. 10B are sectional views of the circumference portion of the photoconductor in the second embodiment seen from a direction perpendicular to the sheet conveying direction;

FIG. 11 is a schematic diagram of a circumference portion of a photoconductor showing a modification of the second embodiment seen from a sheet conveying direction; and

FIG. 12 is a schematic diagram of an image forming unit in a third embodiment seen from a direction perpendicular to a sheet conveying direction.

### DETAILED DESCRIPTION

In general, according to one embodiment, there is provided a developing device including: a developer container to contain developer having toner and carrier; a toner replenishing unit to replenish the toner to the developer container; a carrier replenishing unit to replenish the carrier to the developer container; a discharge portion to discharge the developer from the developer container; a developer feeder to carry the developer in the developer container and to feed the toner in the developer to a photoconductor on which an electrostatic latent image is formed; an electric conductor, provided separately from the photoconductor, to which the toner out of the developer supported by the developer feeder adheres; a detecting unit to detect a density of the toner adhered to on the electric conductor; and a controller to judge a deterioration status of the developer based on a detection result of the detecting unit and to replenish the toner and the carrier from the toner replenishing unit and the carrier replenishing unit to the developer container.

Hereinafter, embodiments will be described with reference to the drawings.

### First Embodiment

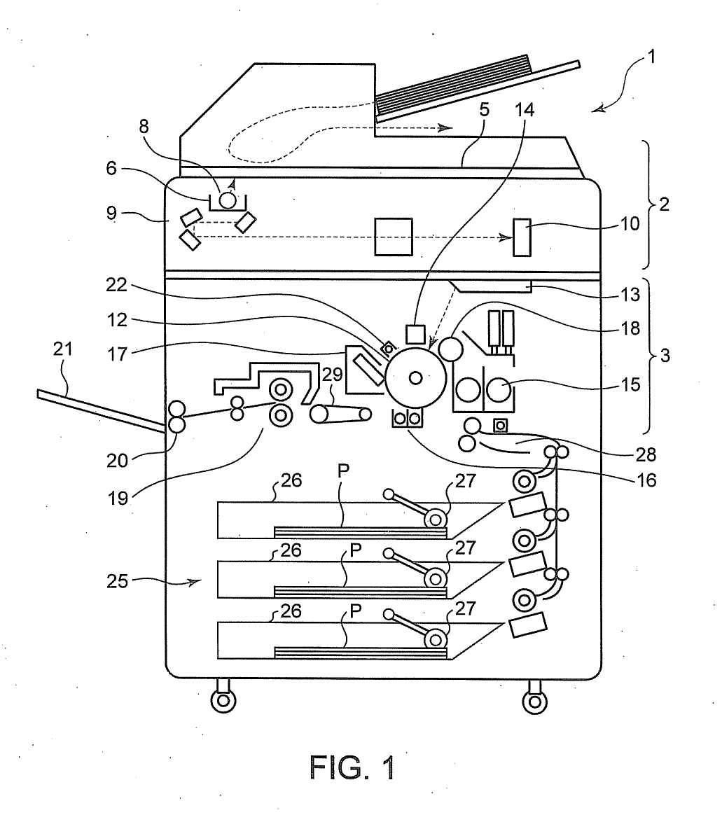

A first embodiment will be described with reference to FIG. 1 through FIG. 5.

FIG. 1 is a sectional view showing an internal construction of an image forming apparatus with a developing device according to the present embodiment.

An image forming apparatus 1 includes an image reader 2 to read in an image of an object to be read and an image forming unit 3 to form an image.

The image reader 2 includes a permeable document table 5, a carriage 6 to reciprocate below the document table 5, an exposure lamp 8 provided in the carriage 6, a reflection mirror 9, and a CCD (Charge Coupled Device) 10 to take in a reflected light and to convert an image information of the light into an electrical signal.

The image forming unit 3 includes a photoconductor 12 and a laser unit 13 to form an electrostatic latent image on the photoconductor 12, and includes a charger 14, a developing device 15 to develop the electrostatic latent image on the photoconductor 12, a transfer device 16 and a cleaner 17 which are arranged at the circumference of the photoconductor 12.

A fixing device 19 to fix an image on a sheet P to which the image is transferred by the transfer device 16 by heat and pressure and sheet ejection rollers 20 to discharge the sheet P on which the image is fixed to a sheet receiving tray 21 that is a sheet discharge portion are provided.

A sheet feeding unit 25 is provided below the image forming unit 3. The sheet feeding unit 25 includes a plurality of cassettes 26, each of which stores sheets P of various sizes. Each of the cassettes 26 includes a pickup roller 27 to take out the sheet P one by one. A sheet conveying path 28 conveys the sheet P which is taken out by the pickup roller 27 to the transfer device 16.

Next, an image forming operation will be described.

An exposing mechanism comprises the carriage 6 and the exposure lamp 8 irradiates light to a document loaded on the document table 5. Light reflected from the document is induced by the reflection mirror 9 and a reflected light image is projected on the CCD 10. An image information taken in the CCD 10 is outputted as an analog information, and then is converted into a digital signal. The digital signal is image processed, and then is transmitted to the laser unit 13.

When the image forming is started, the charger 14 charges at a prescribed charging position and feeds the prescribed charge to an outer circumference of the rotating photoconductor 12. The laser unit 13 irradiates laser beam according to the transmitted image information on the outer circumference face of the photoconductor 12 which is charged in a uniform potential in the axial direction by the charger 14. By the irradiation of the laser beam, an electrostatic latent image corresponding to the image information of the document is formed on the outer circumference face of the photoconductor 12. The developing device 15 feeds developer to the electrostatic latent image on the photoconductor 12, and the electrostatic image is converted to a toner image. That is, the electrostatic latent image is developed.

As the developer, two-component system developer is used in which toner and carrier are agitation mixed and the toner is carried by the carrier.

A developer feeder 18 is provided at the developing device 15 so as to rotate freely. By the rotation of the developer feeder 18 while being arranged to face the photoconductor 12, the developer feeder 18 feeds the toner on the photoconductor 12. When the toner image is formed on the photoconductor 12, the toner image is electrostatically transferred by the transfer device 16 on the sheet P conveyed through the sheet conveying path 28 from the sheet feeding unit 25. The sheet P on which the toner image is transferred is conveyed to the fixing device 19 by a conveying belt 29. The toner image transferred on the sheet P is fixed on the sheet P by heat and pressure by the fixing device 19. The sheet P in which the image forming is finished by fixing the toner image is discharged on the sheet receiving tray 21 by the sheet ejection rollers 20.

After the toner which is not transferred and remains on the photoconductor 12 is removed by the cleaner 17, the residual charge on the photoconductor 12 is removed by a neutralization lamp 22.

Next, the image forming unit 3 including the developing device 15 will be described.

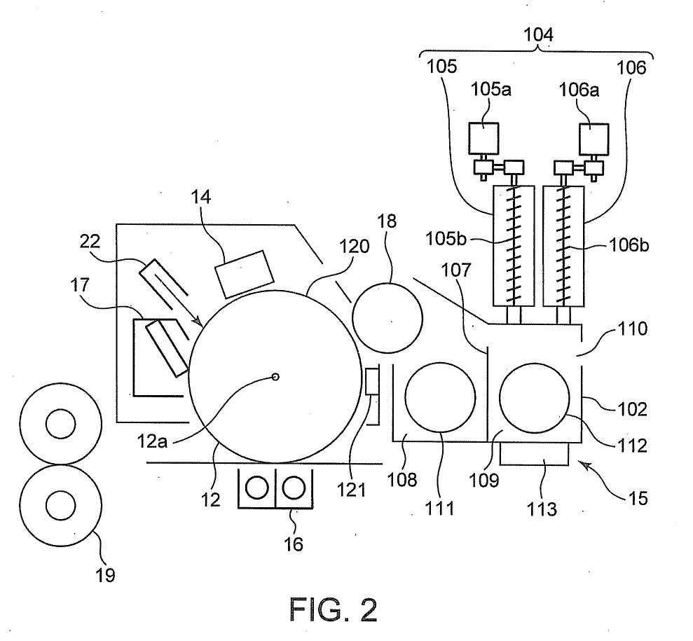

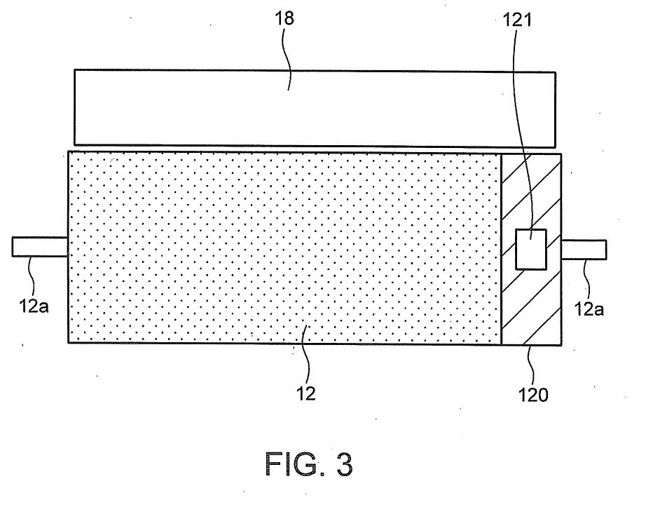

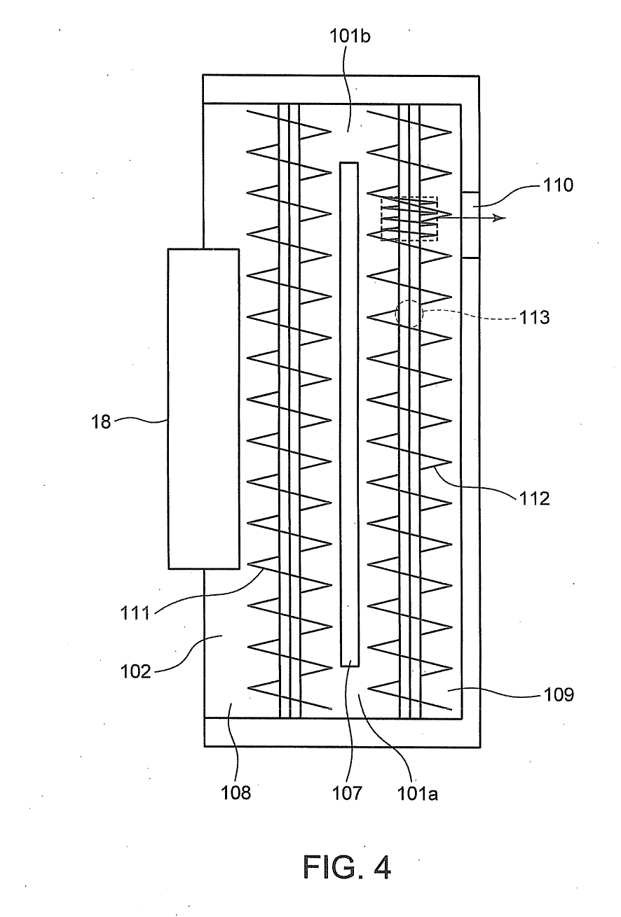

FIG. 2 is a schematic diagram showing a construction of the image forming unit 3 including the photoconductor 12 and the developing device 15. FIG. 3 is a schematic diagram of a circumference portion of the photoconductor 12 seen from the sheet conveying direction. FIG. 4 is a plan view of the developing device 15 seen from above.

As shown in FIG. 2, the developer feeder 18 is arranged facing the photoconductor 12. The developer feeder 18 feeds the developer to the electrostatic latent image formed on the photoconductor 12 and forms the toner image. The developer feeder 18 comprises a developing sleeve and a magnet provided in the developing sleeve. The carrier composed of magnetic material forms a magnetic brush on the developing sleeve by the magnet. When the magnetic brush comes in contact with the photoconductor 12, the toner adhered to the carrier is electrostatically pulled in to the outer circumference face of the photoconductor 12, and forms the toner image. An electric conductor 120 (hereinafter, referred to as ring) with the same diameter as that of the photoconductor 12 is arranged at an end of the rotary shaft 12a of the photoconductor 12. The ring 120 is provided as a separate member from the photoconductor 12 to form the toner image. The photoconductor 12 and the ring 120 are electrically conducting via the rotary shaft 12a.

As shown in FIG. 3, the ring 120 faces the developer feeder 18. As a potential difference generates between the ring 120 and the developer feeder 18, the developer is also fed to the ring 120, and the toner adheres to the ring 120. A deterioration sensor 121 to detect the density of the toner adhered to on the ring 120 is arranged adjacent to the ring 120.

The developing device 15 includes a developer container 102. The developer feeder 18 is provided at an opening portion of the developer container 102. The developer is fed from the developing container 102 to the developer feeder 18. That is, the developer feeder 18 is charged positively, and adsorbs the developer from the developing container 102. A developer replenishing device 104 is provided at an upper portion of the developer container 102. The developer replenishing device 104 includes a carrier replenishing case (carrier replenishing unit) 105 and a toner replenishing case (toner replenishing unit) 106. A carrier conveying motor 105a replenishes the carrier from the carrier replenishing case 105 to the developing container 102 by driving an auger 105b. A toner conveying motor 106a replenishes the toner from the toner replenishing case 106 to the developing container 102 by driving an auger 106b. The developer container 102 is divided into a first space 108 and a second space 109 by a partition plate 107. The developer replenishing device 104 is arranged at an upper portion of the second space 109. The toner and the carrier are replenished into the second space 109.

As shown in FIG. 4, the first space 108 and the second space 109 communicate with each other via continuous paths 101a and 101b. As a circulation mechanism to circulate the developer between the first space 108 and second space 109 mutually, a first mixer 111 is provided in the first space 108 and a second mixer 112 is provided in the second space 109. By the rotation of the first mixer 111 and the second mixer 112, the developer in the developing container 102 is agitated and conveyed.

A developer discharge spout 110 is provided at a side face of the second space 109 of the developer container 102. The redundant developer is discharged from the developer discharge spout 110. A toner density sensor 113 to detect the density of the toner of the developer which is agitated and conveyed by the second mixer 112 is provided at the second space 109. Depending on the toner density detected by the toner density sensor 113, a replenishing amount of the toner from the toner replenishing case 106 to the developing container 102 is controlled.

Next, a method for detecting deterioration of developer will be described.

As the deterioration of the developer is caused mainly by the deterioration of the carrier, the deterioration detection of the developer described below may be thought as to detect the level of the deterioration of the carrier.

The deterioration detection of the developer is performed using the ring 120 and the deterioration sensor 121. The ring 120 is at the ground potential via the rotary shaft 12a of the photoconductor 12. For the reason, when the developing is performed at the photoconductor 12, a surface potential of the ring 120 becomes to the ground potential, and a potential difference is caused between the developer feeder 18, and the toner with low charging amount which is in charging fault adheres to on the ring 120. That is, if the toner is charged well, the toner does not almost adhere to on the ring 120. That is, the more the toner with low charging amount which is in charging fault is, the more the toner adheres to on the ring 120.

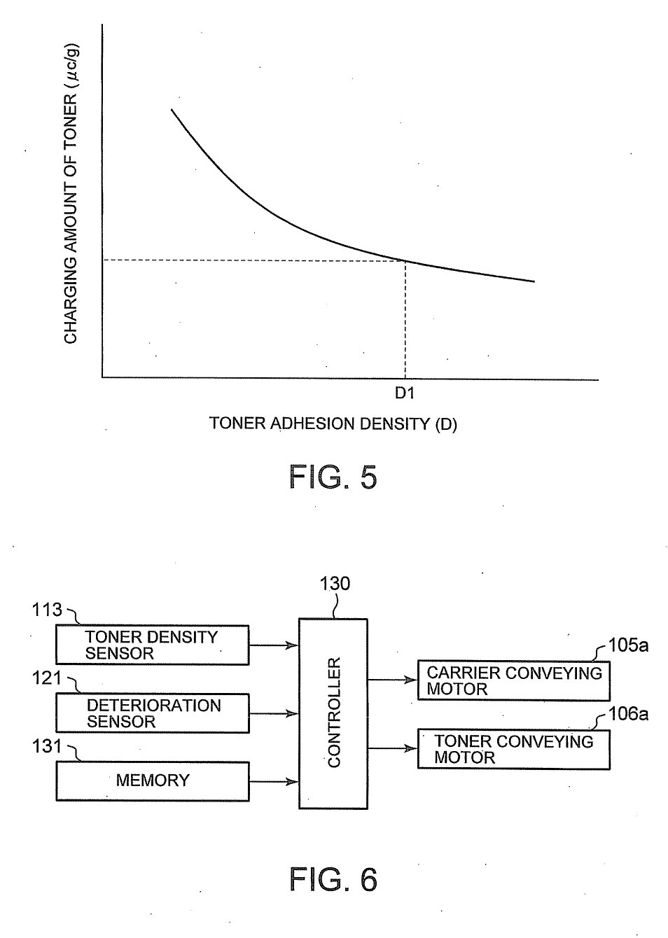

FIG. 5 indicates a relation between a charging amount (μC/g) of a toner and a toner adhesion density (D) of the toner adhered to the surface of the ring 120. That the lower the charging amount of the toner becomes, the higher the toner adhesion density (D) becomes can be read out.

As the charging amounts of the toner are different when the carrier has deteriorated or not, the amounts of the toner adhered to on the ring 120, that is the toner adhesion densities on the ring 120 become different. That is, by detecting the toner adhesion density on the ring 120, the level of the deterioration of the carrier can be known. For the reason, the level of the deterioration is judged by measuring the toner adhesion density on the surface of the ring 120 with the deterioration sensor 121,

As the deterioration sensor 121, an optical sensor is used, which detects a reflected light in case that light is irradiated on the ring 120. If the toner adhesion densities are different, reflection coefficients in case of irradiating light become different, so that the toner adhesion density on the ring 120 can be detected by measuring the reflection coefficient of the light irradiated on the ring 120.

FIG. 6 is a block diagram to explain a controller 130 so as to perform replenishment and discharge control of the developer in accordance with the deterioration of the developer used in the developing device 15. The controller 130 controlling whole the image forming processing performs the replenishment and discharge control of the developer.

With respect to the replenishment and discharge control of the developer, a toner density sensor 113, the deterioration sensor 121 and a memory 131 are connected to an input side to the controller 130. The carrier conveying motor 105a used in case of conveying the carrier from the carrier replenishing case 105 to the developer container 102 and the toner conveying motor 106a used in case of conveying the toner from the toner replenishing case 106 to the developer container 102 are connected to an output side from the controller 130.

That the toner density in the developer falls is judged in the controller 130 by the toner density sensor 113, the toner conveying motor 106a is driven and the auger 106b rotates. The toner is replenished to the developer container 102 by the rotation of the auger 106a. The memory 131 stores a toner adhesion density D1 of a minimum level appropriate for image forming on the sheet P. When the toner adhesion density detected by the deterioration sensor 121 becomes not less than D1, that the charging amount of the toner falls and the charging fault takes place due to the deterioration of the carrier is judged by the controller 130. And, the carrier conveying motor 105a is driven so as to replenish the carrier from the carrier replenishing case 105 to the developer container 102, and the auger 105b is rotated.

When the toner and the carrier are replenished, the redundant developer is discharged from developer discharge spout 110.

The controller 130 controls such that the detection of the toner adhesion density on the ring 120 by the deterioration sensor 121 is performed, after replenishing the toner and when the toner density in the developer container 102 becomes uniform by the toner density sensor 113. That is, by performing the deterioration detection when the toner density becomes uniform in the developer container 102, the difference between the values detected by the deterioration sensor 121 due to the difference between the toner densities can be eliminated.

As the ring 120 with the same diameter as that of the photoconductor 12 is provided coaxial with the photoconductor 12, a cleaner to remove the toner adhered to on the ring 120 can be shared with the cleaner 17 of the photoconductor 12. In such the construction, the apparatus can be simplified without the need for increasing extra members.

By employing the above-described construction, the developer is fed from the developer feeder 18 to the electric conductor (ring 120) provided adjacent to the photoconductor 12, and by detecting the toner amount adhered to on the electric conductor, the level of deterioration of the developer can be detected easily. As the carrier can be replenished effectively in accordance with the level of the deterioration of the developer, a high image quality can be maintained. In addition, as the old carrier is discharged by replenishing the new carrier only when the carrier has deteriorated, the wasteful consumption of the carrier can be prevented.

### Second Embodiment

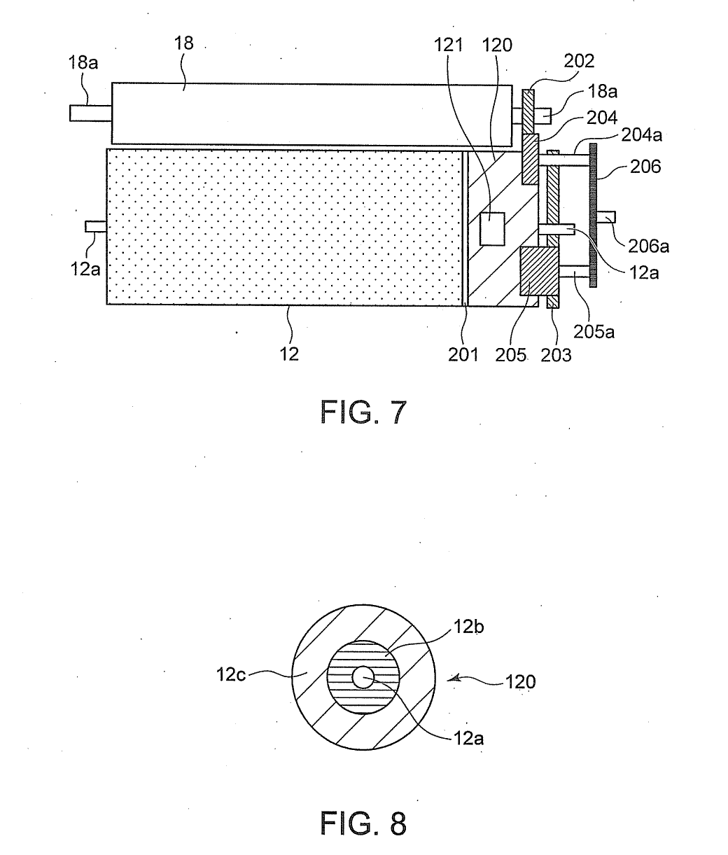

Next, a second embodiment will be described with reference to FIG. 7 through FIG. 10.

Hereinafter, the same reference numerals are used for the same components in the first embodiment, and only the characteristic potions of the present embodiment will be described.

In the second embodiment, the deterioration detection of the developer is not always performed, but is performed only after the toner is replenished from the toner replenishing case 106 and when the toner density in the developer container 102 becomes constant. If the toner adheres to on the ring 120 when the deterioration detection is not performed, the toner comes to nothing.

In order to eliminate such a wasteful consumption of the toner, the present embodiment employs a mechanism such that when the deterioration detection is not performed the toner is not made to adhere to on the ring 120, and only when the deterioration detection is performed the toner is made to adhere to on the ring 120.

Specifically, a following mechanism is used. The development is performed on the photoconductor 12 by the developer feeder 18, as there is a potential difference between the photoconductor 12 and the developer feeder 18, the toner adheres to on the photoconductor 12. In other words, if the ring 12 and the developer feeder 18 are at the same potential, the toner does not adhere to on the ring 120. For the reason, the present embodiment includes a potential switching mechanism to switch between a case that there is a potential difference between the ring 120 and the developer feeder 18 and a case that the ring 12 and the developer feeder 18 are at the same potential.

FIG. 7 is a sectional view of a mechanism at the circumference of the photoconductor 12 seen from the sheet conveying direction.

Different from the first embodiment, an insulating ring 201 is arranged between the photoconductor 12 and the ring 120. In the ring 120, an insulator 12b at the circumference of the rotary shaft 12a and an electric conductor 12c at the outer circumference of the insulator 12b are formed as shown in FIG. 8. Therefore, as the central portion of the ring 120 which contacts the rotary shaft 12a of the photoconductor 12 is constructed as the insulator 12b, the outer circumference of the ring 120 is not electrically conducting to the rotary shaft 12a. The photoconductor 12 and the rotary shaft 12 are electrically conducting.

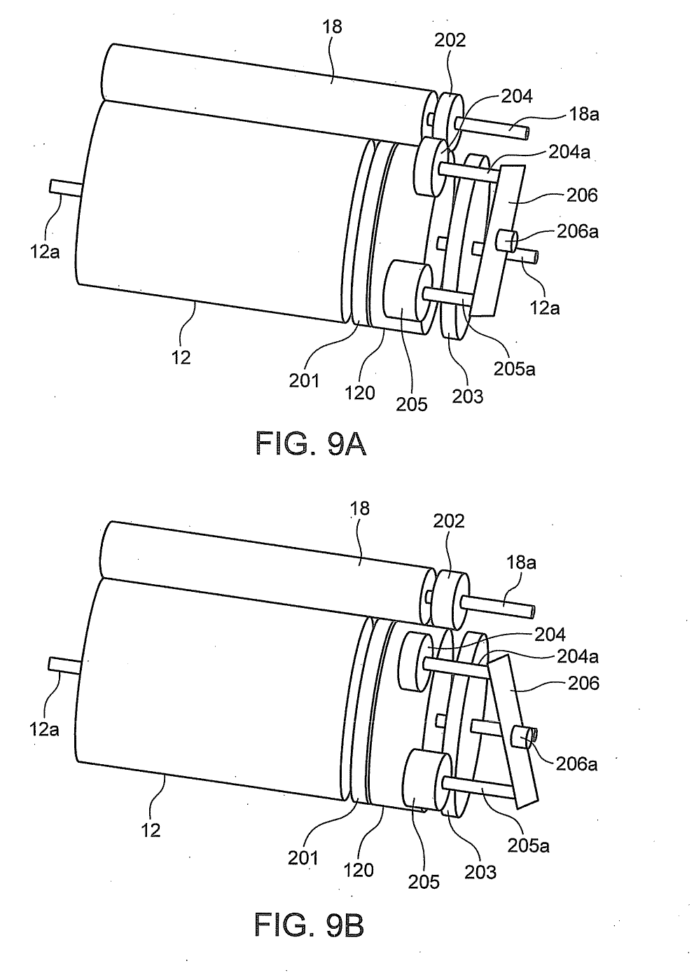

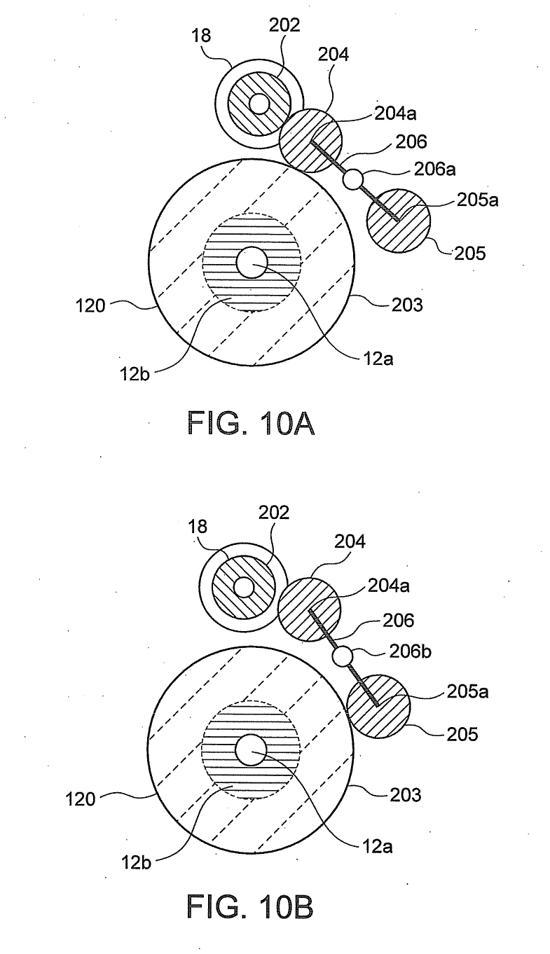

As shown in FIG. 7, FIG. 9 and FIG. 10, a first electric conducting ring 202 which is electrically conductive is provided on a rotary shaft 18a of the developer feeder 18. The first electric conducting ring 202 is electrically conducting to the developer feeder 18 via the rotary shaft 18a. A second electric conducting ring 203 which is electrically conductive is provided on the rotary shaft 12a of the photoconductor 12. The second electric conducting ring 203 is electrically conducting to the photoconductor 12 via the rotary shaft 12a.

A third electric conducting ring 204 and a fourth electric conducting ring 205 which are both electrically conductive are fitted to a plate 206 which is an insulation material, respectively, via a rotary shaft 204a of the third electric conducting ring 204 and a rotary shaft 205a of the fourth electric conducting ring 205. The plate 206 is provided so as to rotate freely assuming that a rotary shaft 206a is a fulcrum point. By the rotation of the plate 206 in one direction (counter-clockwise direction in FIG. 10), the third electric conducting ring 204 comes in contact with the first electric conducting ring 202 and the ring 120 (FIG. 9A and FIG. 10A). By the rotation of the plate 206 in another direction (clockwise direction in FIG. 10), the fourth electric conducting ring 205 comes in contact with the second electric conducting ring 203 and the ring 120 (FIG. 9B and FIG. 10B).

When the electric conducting rings are contacting with each other and when the electric conducting ring is contacting the ring 120, they are electrically conducting and at the same potential.

In case that the deterioration detection of the developer is not performed, as a result of the rotation of the plate 206 in one direction, the position relation of the four first through fourth electric conducting rings becomes in the state shown in FIG. 9A and FIG. 10A. In this time, the first electric conducting ring 202 is contacting the third electric conducting ring 204. In addition, the third electric conducting ring 204 is contacting the ring 120. For the reason, the developer feeder 18 is electrically conducting to the ring 120 via the first electric conducting ring 202 and the third electric conducting ring 204. That is, as the ring 120 and the developer feeder 18 are at the same potential, the toner does not adhere to on the ring 120.

In case that the deterioration detection of the developer is performed, as a result of the rotation of the plate 206 in another direction, the position relation of the four first through fourth electric conducting rings becomes in the state shown in FIG. 9B and FIG. 10B. In this time, the third electric conducting ring 204 does not contact the first electric conducting ring 202 and the ring 120. For the reason, the developer feeder 18 is not electrically conducting to the ring 120 via the first electric conducting ring 202 and the third electric conducting ring 204.

As a result of the rotation of the plate 206 in another direction, the fourth electric conducting ring 205 comes in contact with the ring 120 and they becomes electrically conducting. As the fourth electric conducting ring 205 comes is contact with also the second electric conducting ring 203 and they becomes electrically conducting, and as the second electric conducting ring 203 is electrically conducting to the rotary shaft 12a, the ring 120 is kept to the ground potential.

In this manner, a potential difference is generated between the developer feeder 18 and the ring 120, and the toner adheres to on the ring 120. For the reason, the toner which has adhered to on the surface of the ring 120 can be detected, and the deterioration detection of the developer can be performed.

By employing the above construction, the toner does not adhere to on the ring 120 except at the time of deterioration detection of the developer. In addition, as the insulating ring 201 is insulating, in case of detecting the toner adhesion density in the state of FIG. 9B, to form the toner image and to detect the toner adhesion density can be made without giving the electrical effect to the photoconductor 12.

In the first embodiment, regardless of whether the deterioration detection is performed or not, the faulty toner always adheres to on the ring 120, but in the present embodiment the toner adheres to on the ring 120 only when the deterioration detection is performed. For the reason, the wasteful consumption of the toner can be eliminated.

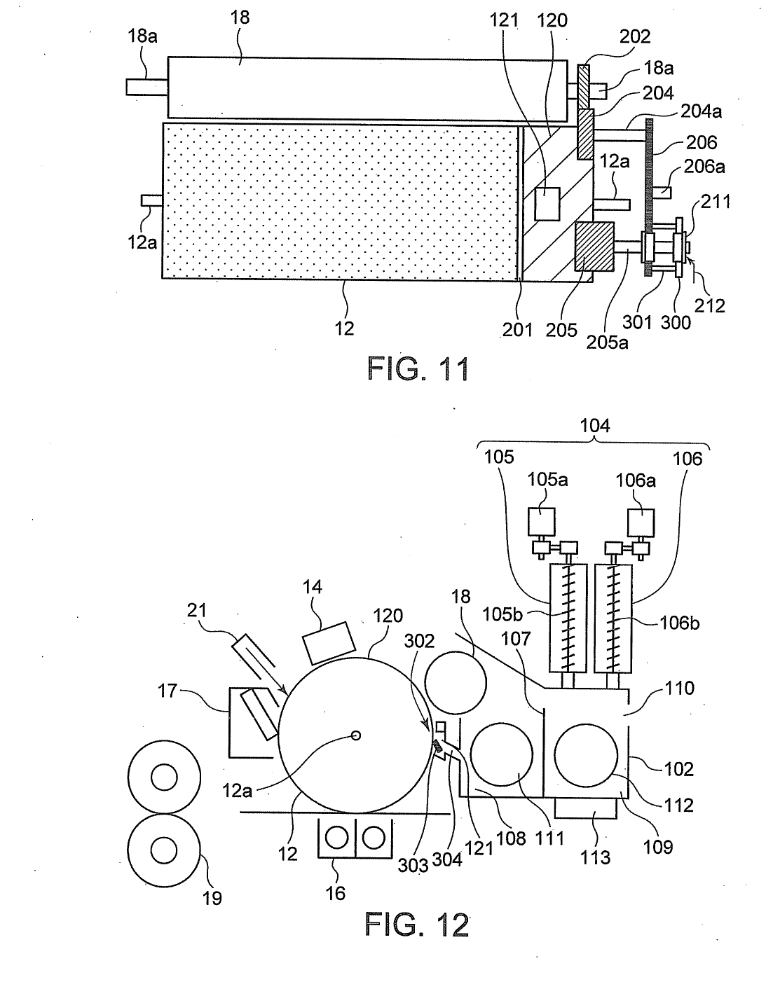

In the above-described embodiment, a construction is employed in which the potential of the ring 120 is at the ground potential in case of performing the deterioration detection of the developer. But another construction may be employed in which the potential of the ring 120 can be changed to a potential except the ground potential. By employing a construction shown in FIG. 11, for example, the potential of the ring 120 can be changed. In the construction, the second electric conducting ring 205 is not necessary to provide. Instead, an electrically conductive shaft 210 is extended from the fourth electric conducting ring 205, the shaft 210 is supported by an electrically conductive bearing 211 to a plate 300 fitted to the plate 206 by a supporting rod 301 and to the plate 206, and in addition, an electrode plate 212 is connected to the electrically conductive bearing 211. By employing such the construction, to change the potential of the ring 120 can be made possible when detecting the deterioration of the developer.

By changing and making the potential of the ring 120 to a potential (positive potential) approximately close to the potential of the developer feeder 18 which is charged positively, a ratio of the toner of charging fault with low charging amount is increased in the toner which adheres to on the ring 120, so that to perform the deterioration detection with more accuracy can be made possible.

In addition, the potential switching mechanism is not limited to the above-described construction, but as a matter of course, to connect or separate by an electrically conductive brush or to switch the potentials by an electronic switch can be employed.

### Third Embodiment

A third embodiment will be described with reference to FIG. 12.

Hereinafter, the same reference numerals are used for the same portions in the first embodiment and only the characteristic portions of the present embodiment will be described.

In the present embodiment, a cleaner 302 to remove the toner adhered to on the ring 120 is provided adjacent to the developing device 15. A mechanism is employed such that the cleaner 302 removes the toner adhered to on the ring 120 using a blade 303, and the removed toner is returned into the developer container 102 via a toner discharge spout 304.

By employing the above-described mechanism, as the toner adhered to on the surface of the ring 120 is removed by the cleaner 302, and the toner used for the deterioration detection is returned into the developer container 102, the wasteful consumption of the toner can be suppressed.

In the above-described embodiments, the toner adhesion amount on the ring 120 is detected using the optical deterioration sensor 121. But, before returning the toner removed by the blade 303 into the developer container 120, to measure the amount of the toner adhered to on the ring 120 is also possible by measuring the weight of the toner.

While certain embodiments have been described, those embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the inventions.

What is claimed is:

1. A developing device, comprising:
a developer container to contain developer having toner and carrier;
a toner replenishing unit to replenish the toner to the developer container;
a carrier replenishing unit to replenish the carrier to the developer container;
a discharge portion to discharge the developer from the developer container;
a developer feeder to carry the developer in the developer container and to feed the toner in the developer to a photoconductor on which an electrostatic latent image is formed;
an electric conductor, provided separately from the photoconductor, to which the toner out of the developer supported by the developer feeder adheres;
a detecting unit to detect a density of the toner adhered to on the electric conductor; and
a controller to judge a deterioration status of the developer based on a detection result of the detecting unit and to replenish the toner and the carrier from the toner replenishing unit and the carrier replenishing unit to the developer container.

2. The device of claim 1, further comprising:
a potential switching mechanism to give a potential difference between the electric conductor and the developer feeder when detection by the detecting unit is performed and to make the electric conductor and the developer feeder to a same potential when the detection by the detecting unit is not performed.

3. The device of claim 1, wherein:
the electric conductor includes a ring, the ring is provided at a rotary shaft to support the photoconductor, and the ring is electrically conducting to the photoconductor via the rotary shaft.

4. The device of claim 3, wherein:
when the developer feeder feeds the toner on the photoconductor, a surface potential of the ring is made to a ground potential via the rotary shaft so that the toner of charging fault with low charging amount adheres to on the ring.

5. The device of claim 1, further comprising:
a cleaner to remove the toner adhered to on a surface of the electric conductor; and
a mechanism to return the toner removed by the cleaner into the developer container.

6. The device of claim 1, wherein:
the electric conductor is a ring with the same diameter as that of the photoconductor which is arranged on a rotary shaft to support the photoconductor.

7. The device of claim 1, wherein:
the detecting unit detects the density of the toner adhered to on the electric conductor when the toner is replenished to the developer container and the density of the toner becomes constant.

8. A developing device, comprising:
a developer container to contain developer having toner and carrier;
a developer replenishing unit to replenish the developer to the developer container;
a discharge portion to discharge the developer from the developer container;
a developer feeder to carry the developer in the developer container and to form a toner image on a photoconductor;
a conductor on which a toner pattern, which is formed independent of the forming the toner image formed by the developer feeder;
a detecting unit to detect a density of the toner adhered to on the electric conductor; and
a controller to judge a deterioration status of the developer based on a detection result of the detecting unit and to replenish the developer to the developer container.

9. The device of claim 8, wherein the developer replenishing unit comprises a toner replenishing unit and a carrier replenishing unit.

10. The device of claim 8, further comprising:
a potential switching mechanism to give a potential difference between the electric conductor and the developer feeder when detection by the detecting unit is performed and to make the electric conductor and the developer feeder to a same potential when the detection by the detecting unit is not performed.

11. The device of claim 8, wherein:
the conductor includes a ring, the ring is provided at a rotary shaft to support and the ring is electrically conducting to the photoconductor via the rotary shaft.

12. The device of claim 11, wherein:
when the developer feeder feeds the toner on the photoconductor, a surface potential of the ring is made to a ground potential via the rotary shaft so that the toner of charging fault with low charging amount adheres to on the ring.

13. The device of claim 8, further comprising:
a cleaner to remove the toner adhered to on a surface of the conductor; and
a mechanism to return the toner removed by the cleaner to the developer container.

14. The device of claim 8, wherein:
the conductor is a ring with the same diameter as that of the photoconductor which is arranged on a rotary shaft to support the photoconductor.

15. The device of claim 8, wherein:
the detecting unit detects the density of the toner adhered to on the conductor when the toner is replenished to the developer container and the density of the toner becomes constant.

16. A method for detecting deterioration of developer, comprising:
developing an electrostatic latent image formed on a photoconductor using a developer having toner and carrier which are contained in a developer container;
making the toner adhere to on an conductor provided separately from the photoconductor when the electrostatic latent image is developed;
detecting a density of the toner adhered to on the conductor;
judging a deterioration state of the developer based on a detection result of the density of the toner adhered to on the conductor; and
replenishing toner and carrier into the developer container based on the deterioration state.

17. The method of claim 16, wherein:
a potential difference is given between the conductor and the developer feeder when detection of the toner adhered to the conductor is performed; and
the conductor and the developer feeder are made to a same potential when the detection of the toner adhered to on the conductor is not performed.

18. The method of claim 16, wherein:
the electric includes a ring, the ring is provided at a rotary shaft to support the photoconductor, and the ring is electrically conducting to the photoconductor via the rotary shaft.

19. The method of claim 18, wherein:
when the developer feeder feeds the toner on the photoconductor, a surface potential of the ring is made to a ground potential via the rotary shaft so that the toner of charging fault with low charging amount adheres to on the ring.

20. The method of claim 16, further comprising:
removing the toner adhered to on the surface of the conductor; and
returning the toner removed to the developer container.
